(19) United States
(12) Patent Application Publication
(10) Pub. No.: US 2023/0129184 A1
(43) Pub. Date: Apr. 27, 2023

(54) FUMES EXHAUST STRUCTURE FOR BATTERY PACK

(71) Applicant: SUBARU CORPORATION, Tokyo (JP)

(72) Inventor: Takahiro SAKAMOTO, Tokyo (JP)

(21) Appl. No.: 17/960,438

(22) Filed: Oct. 5, 2022

(30) Foreign Application Priority Data
Oct. 21, 2021 (JP) 2021-172532

(51) Int. Cl. H01M 50/358

(52) U.S. Cl. CPC H01M 50/358; H01M 2220/20

(57) ABSTRACT

A fumes exhaust structure for a battery pack exhausts a fuming gas generated in a battery module in a battery case due to an abnormality to outside a vehicle compartment. The fumes exhaust structure includes a fumes exhaust duct, an inverter, an inverter casing, and a fan. The fumes exhaust duct is disposed near the battery module to communicate with it. The inverter casing is disposed on a periphery of the battery case to communicate with it. The fan is disposed inside the battery case and sends air to the inverter casing. The fumes exhaust structure has first and second fumes exhaust paths. The first fumes exhaust path is used to exhaust the fuming gas to outside the vehicle compartment via the fumes exhaust duct. The second fumes exhaust path is used to exhaust the fuming gas to outside the vehicle compartment via the inverter casing.

### CROSS-REFERENCE TO RELATED APPLICATIONS

The present application claims priority from Japanese Patent Application No. 2021-172532 filed on Oct. 21, 2021, the entire contents of which are hereby incorporated by reference.

### BACKGROUND

The disclosure relates to a fumes exhaust structure for a battery pack, which exhausts a fuming gas generated in a battery cell due to an abnormality in the battery pack to the outside of a compartment of a vehicle.

As an example of a known fumes exhaust structure for a battery pack, the structure disclosed in Japanese Unexamined Patent Application Publication No. 2009-277647, for example, is known.

A battery module is a vehicle battery set loaded in a vehicle, such as an automobile or a train. Multiple battery modules are stored in a battery case of a battery pack. A gas exhaust duct is disposed on the top and bottom surfaces of the battery modules along a direction in which the battery modules are arranged. The gas exhaust duct, which is formed in the shape of a rectangular pipe having an internal passage, passes through the battery case and extends to the outside.

Gas inlets and air inlets are formed in the gas exhaust duct. The gas inlets communicate with gas exhaust vents of the battery modules. The air inlets take part of cooling air into the gas exhaust duct. A fuming gas containing toxic substances exhausted from a battery module flows into the internal passage of the gas exhaust duct via the gas inlets. The fuming gas is then exhausted to the outside of the compartment of the vehicle via the gas exhaust duct while utilizing a flow of cooling air.

### SUMMARY

An aspect of the disclosure provides a fumes exhaust structure for a battery pack. The fumes exhaust structure is configured to exhaust a fuming gas from inside of a battery case to outside of a compartment of a vehicle. The fuming gas is to be generated in a battery cell of a battery module stored in the battery case due to an abnormality in the battery module. The fumes exhaust structure includes a fumes exhaust duct, an inverter, an inverter casing, and a fan. The fumes exhaust duct is disposed near the battery module so as to communicate with the battery cell. The inverter is configured to convert a current output from the battery module. The inverter casing for the inverter is disposed on a periphery of the battery case so as to communicate with the battery case. The fan is disposed inside the battery case and is configured to send air inside the battery case to the inverter casing. The fumes exhaust structure has first and second fumes exhaust paths. The first fumes exhaust path is to be used to exhaust the fuming gas to outside of the compartment of the vehicle via the fumes exhaust duct. The second fumes exhaust path is to be used to exhaust the fuming gas from the battery case to outside of the compartment of the vehicle via the inverter casing.

### BRIEF DESCRIPTION OF THE DRAWINGS

The accompanying drawings are included to provide a further understanding of the disclosure and are incorporated in and constitute a part of this specification. The drawings illustrate an example embodiment and, together with the specification, serve to describe the principles of the disclosure.

FIG. 1 is a schematic view illustrating a vehicle including a fumes exhaust structure for a battery pack according to an embodiment;

FIG. 2 is a sectional view illustrating the fumes exhaust structure for the battery pack according to the embodiment;

FIG. 3 is a schematic view illustrating the fumes exhaust structure for the battery pack according to the embodiment;

FIG. 4 is a block diagram illustrating the fumes exhaust structure for the battery pack according to the embodiment; and

FIG. 5 is a flowchart illustrating a control method for exhausting a fuming gas inside the fumes exhaust structure to the outside of the compartment of the vehicle according to the embodiment.

### DETAILED DESCRIPTION

In a gas exhaust duct, plural gas inlets and plural air inlets are formed. With the aid of a flow of cooling air, even a small amount of fuming gas generated from a battery module can be exhausted to the outside of the compartment of a vehicle.

To prevent a leakage of a fuming gas into a battery case, a sealing member may be used at a joint portion between the gas inlets of the gas exhaust duct and the battery module. To absorb vibrations of the vehicle in action and to accommodate variations of assembling between the gas inlets and the battery module, it is desirable to use a sealing member made of a material having high flexibility.

Even with the use of this type of sealing member, however, it is difficult to totally prevent a leakage of a fuming gas from the gas inlets to the inside of the battery case. A fuming gas may also leak to the inside of the battery case for a reason, such as the aging degradation of the sealing member.

If the gas exhaust duct is the only exhaust path through which a fuming gas can be exhausted to the outside of the compartment of the vehicle, a fuming gas having leaked to the inside of the battery case is not exhausted to the outside of the compartment. A fuming gas may flow out to the compartment of the vehicle from the battery case and be highly concentrated in the compartment. This may adversely influence occupants in the vehicle.

It is thus desirable to provide a fumes exhaust structure for a battery pack, which exhausts a fuming gas generated in a battery cell due to an abnormality in a battery pack to the outside of a compartment of a vehicle.

A fumes exhaust structure 11 for a battery pack 10 according to an embodiment of the disclosure will now be described below in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. The front-back direction in the plane of the drawings indicates the front-rear direction of a vehicle 12, the left-right direction in the plane of the drawings indicates the widthwise direction of the vehicle 12, and the top-bottom direction in the plane of the drawing indicates the height direction of the vehicle 12.

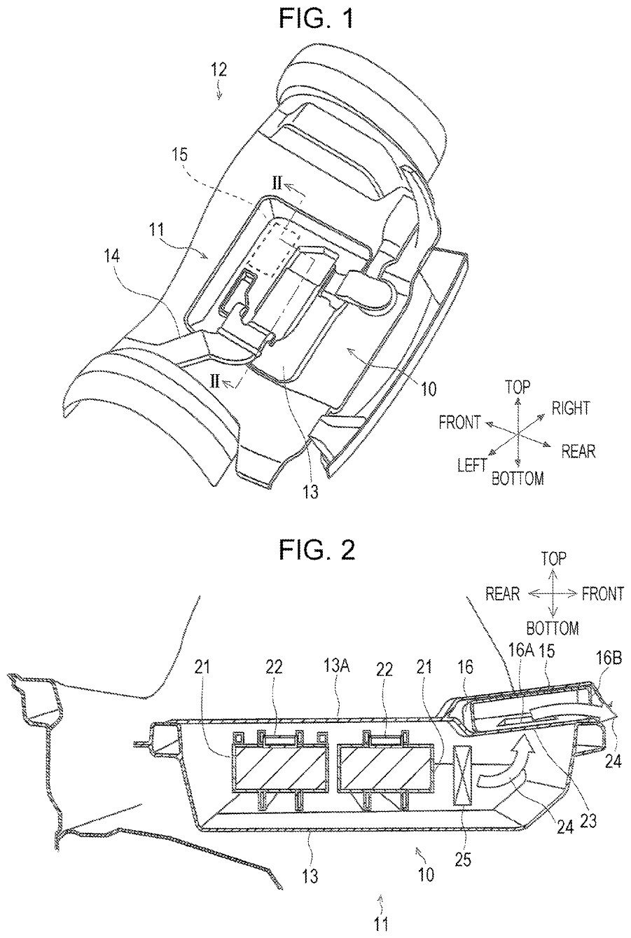

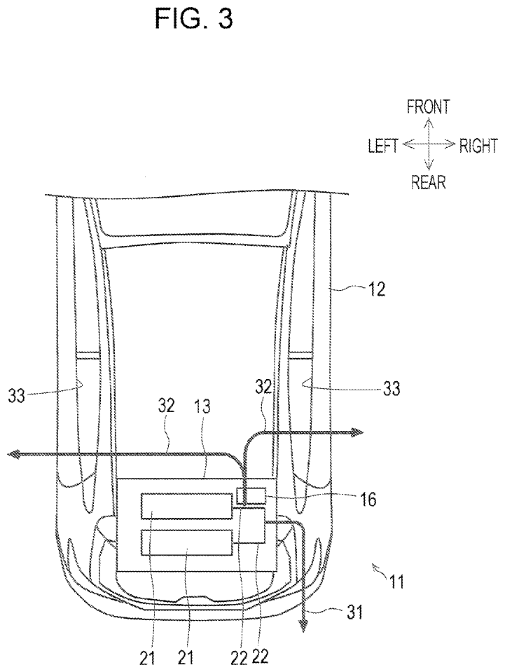

FIG. 1 is a schematic view illustrating the vehicle 12 including the fumes exhaust structure 11 for the battery pack 10 according to the embodiment. FIG. 2 is a sectional view illustrating the fumes exhaust structure 11 for the battery pack 10 according to the embodiment. FIG. 3 is a schematic view for explaining fumes exhaust paths of the fumes exhaust structure 11 for the battery pack 10 according to the embodiment.

As illustrated in FIG. 1, the battery pack 10 is loaded in the vehicle 12, such as an automobile or a train, to supply electric power to a motor and various other electrical components. Examples of an automobile which may serve as the vehicle 12 are an electric vehicle (EV), a hybrid electric vehicle (HEV), and a plug-in hybrid electric vehicle (PHEV), which are coming into widespread use.

The battery pack 10 is disposed in a storage space under the rear floor on the rear side of the vehicle 12, for example. Inside a battery case 13 of the battery pack 10, plural battery modules 21 (see FIG. 2) are stored. The plural battery modules 21 are coupled in series with or in parallel with each other or in series with and in parallel with each other.

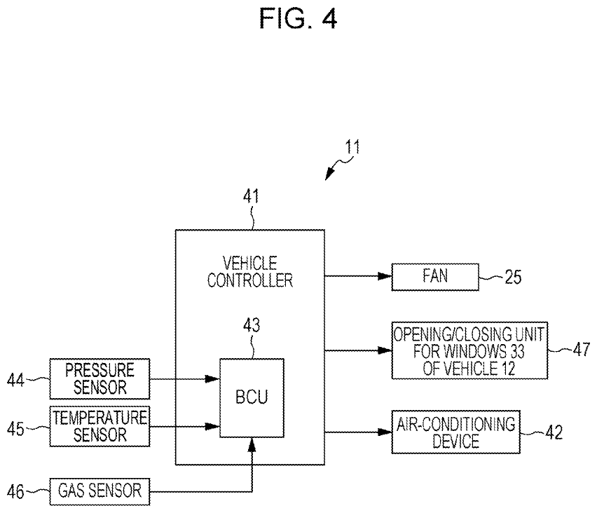

A cooling air channel 14 is disposed near the upper end of the battery case 13. Air cooled in an air-conditioning device 42 (see FIG. 4) of the vehicle 12, for example, flows through the cooling air channel 14. One end of the cooling air channel 14 communicates with the battery case 13 and cooling air flows into the battery case 13.

Cooling air flows through the battery case 13 along the longitudinal direction of the battery modules 21. Cooling air flows to an outlet (not illustrated) of the battery case 13 while performing heat exchange with battery cells so as to cool the battery cells. Then, cooling air is output to the inside of the compartment of the vehicle 12 from the battery case 13 via the outlet. With this structure, the battery cells of the battery modules 21 are maintained at a preset temperature range, so that the battery modules 21 can achieve a certain level of the discharging characteristics and that of the charging characteristics.

As illustrated in FIG. 1, an inverter 15 is located at the upper end of the battery case 13, such as near the corner of the right front side of the fumes exhaust structure 11 toward the right front side of the vehicle 12. The inverter 15 includes an inverter casing 16 (see FIG. 2) formed in a substantially cuboid shape and an inverter circuit stored in the inverter casing 16. The inverter 15 converts a direct current (DC) output from the battery modules 21 into an alternating current (AC) and the converted AC is supplied to a driving motor and various other loads of the vehicle 12, for example.

A fan 25 (see FIG. 2) is disposed inside the battery case 13. The fan 25 is driven to send part of the above-described cooling air inside the battery case 13 to the inside of the inverter casing 16. The cooling air cools the inverter 15. The inverter 15 is thus maintained at a preset temperature range and achieves a certain level of the characteristics. Details of the fan 25 will be discussed later.

FIG. 2 is a sectional view of the battery pack 10 taken along line II-II in FIG. 1. As illustrated in FIG. 2, two battery modules 21 extending in the widthwise direction (left-right direction in the plane of the drawing) of the vehicle 12 are disposed inside the battery case 13. Each of the battery modules 21 is constituted by multiple battery cells (not illustrated), and the battery cells are coupled in series with each other via a busbar (not illustrated).

The battery cells are secondary cells, such as nickel-metal hydride batteries or lithium-ion batteries. The battery cells each have a rectangular flat shape, for example, and are arranged at substantially equal intervals along the longitudinal direction (left-right direction in the plane of the drawing) of the battery modules 21. Adjacent battery cells have a small gap therebetween in the front-rear direction to enhance the cooling efficiency.

A fumes exhaust duct 22 is disposed along the longitudinal direction of each battery module 21 so as to cover the top side of a gas exhaust valve (not illustrated) of each battery cell of the battery module 21. When a battery cell is operating properly, the gas exhaust valve is closed to cause the fumes exhaust duct 22 not to communicate with the battery cell. In contrast, in the case of the occurrence of an abnormality in a battery cell, the gas exhaust valve is opened due to a rise in the internal pressure of the battery cell, thereby causing the fumes exhaust duct 22 to communicate with the battery cell. Then, a fuming gas containing toxic substances generated from the battery cell flows into the fumes exhaust duct 22.

The fumes exhaust duct 22 is disposed in each battery module 21. The plural fumes exhaust ducts 22 merge into one duct within the battery case 13 and the merged fumes exhaust duct 22 extends to the outside of the battery case 13. The end of the fumes exhaust duct 22 is located outside the compartment of the vehicle 12. With this structure, a fuming gas generated in a battery cell is exhausted to the outside of the compartment of the vehicle 12 via the fumes exhaust duct 22.

In the case of the occurrence of an abnormality, such as overcharging or overheating, in a battery cell of the battery module 21, an electrolyte is volatilized or decomposed, or an electrode is decomposed, or another member is thermally decomposed, thereby generating a fuming gas containing toxic substances for the human body.

As illustrated in FIG. 2, the inverter casing 16 is disposed on the top side of the battery case 13. The inverter casing 16 is separated from the inside of the battery case 13 with a steel strip 23 interposed therebetween and is fixed on the top surface of the steel strip 23. An air inlet 16A is formed on the bottom surface of the inverter casing 16, while a communicating port (not illustrated) is formed in the steel strip 23. The inverter casing 16 communicates with the battery case 13 via the air inlet 16A and the communicating port.

The fan 25 is disposed near the battery modules 21 inside the battery case 13 and under the inverter casing 16. The fan 25 is an axial flow fan, for example, and blows part of the above-described cooling air inside the battery case 13 toward the front side of the vehicle 12. As indicated by arrows 24 in FIG. 2, the cooling air flows upward to follow the shape of the battery case 13 and is blown into the inverter casing 16 via the communicating port and the air inlet 16A. Then, the cooling air flows through the inside of the inverter casing 16 and is then exhausted to the inside of the compartment of the vehicle 12 via an air outlet 16B of the inverter casing 16.

The battery case 13 is closed by a top plate 13A so as to store the inverter casing 16 therein. The inverter casing 16 may not necessarily be separated from the battery case 13 with the steel strip 23 therebetween and be stored within the battery case 13. The inverter casing 16 may be configured in any manner if it is disposed on a periphery of the battery case 13 and communicates with the battery case 13 so as to receive the above-described cooling air supplied from the battery case 13 via the fan 25.

An explanation will be given of a path through which a fuming gas containing toxic substances generated in a battery cell of the battery module 21 is exhausted to the outside of the vehicle 12. As this path, the fumes exhaust structure 11 has a first fumes exhaust path 31 and a second fumes exhaust path 32, as illustrated in FIG. 3.

The first fumes exhaust path 31 is a path utilizing the fumes exhaust duct 22. As discussed above, the fumes exhaust duct 22 is disposed along the longitudinal direction of the battery module 21 so as to cover the top side of the gas exhaust valve of each battery cell of the battery module 21. In the case of the occurrence of an abnormality of a battery cell, the gas exhaust valve is opened due to a rise in the internal pressure of the battery cell and a fuming gas generated from the battery cell flows into the fumes exhaust duct 22.

The fumes exhaust duct 22 extends to the outside of the battery case 13 and the end of the fumes exhaust duct 22 is disposed outside the compartment of the vehicle 12. With this structure, a fuming gas generated from a battery cell is exhausted to the outside of the compartment of the vehicle 12 via the fumes exhaust duct 22. That is, the first fumes exhaust path 31 is a path through which a fuming gas is exhausted to the outside of the compartment of the vehicle 12 via the fumes exhaust duct 22.

The second fumes exhaust path 32 is a path utilizing a cooling air channel of the inverter 15. As discussed above, the inverter casing 16 communicates with the battery case 13 via the air inlet 16A and the communicating port. Cooling air sent to the inside of the battery case 13 is blown into the inverter casing 16 via the fan 25. Then, the cooling air flows through the inside of the inverter casing 16, cools the inverter circuit, and is then output to the inside of the compartment of the vehicle 12 from the air outlet 16B. A fuming gas output to the compartment of the vehicle 12 is exhausted to the outside of the compartment through windows 33 of the vehicle 12, which are fully opened under the control of a vehicle controller 41. Exhausting of a fuming gas to the outside of the vehicle 12 under the control of the vehicle controller 41 will be discussed later in detail.

That is, the second fumes exhaust path 32 is a path through which a fuming gas flowing into the battery case 13 is exhausted to the outside of the compartment of the vehicle 12 by utilizing the cooling air channel of the inverter 15 and the windows 33 that are automatically controlled by the vehicle controller 41. The majority of a fuming gas generated from a battery cell is exhausted to the outside of the compartment of the vehicle 12 via the first fumes exhaust path 31.

A sealing member (not illustrated) is used at a joint portion between the fumes exhaust duct 22 and the battery module 21. To absorb vibrations of the vehicle 12 in action and to accommodate variations of assembling between the fumes exhaust duct 22 and the battery module 21, a sealing member made of a material having high flexibility, such as polyurethane foam, is used. Even with the use of this type of sealing member, it is difficult to totally prevent a leakage of a fuming gas from the above-described joint portion to the inside of the battery case 13. A fuming gas generated from a battery cell thus partially leaks to the inside of the battery case 13.

As described above, in the fumes exhaust structure 11 for the battery pack 10 according to the embodiment, the second fumes exhaust path 32 is used to actively exhaust a fuming gas inside the battery case 13 to the outside of the compartment of the vehicle 12. It is thus less likely that a fuming gas remains inside the battery case 13 with an increased concentration and leaks to the inside of the compartment of the vehicle 12 from the battery case 13. Occupants in the vehicle 12 can thus be protected from the fuming gas.

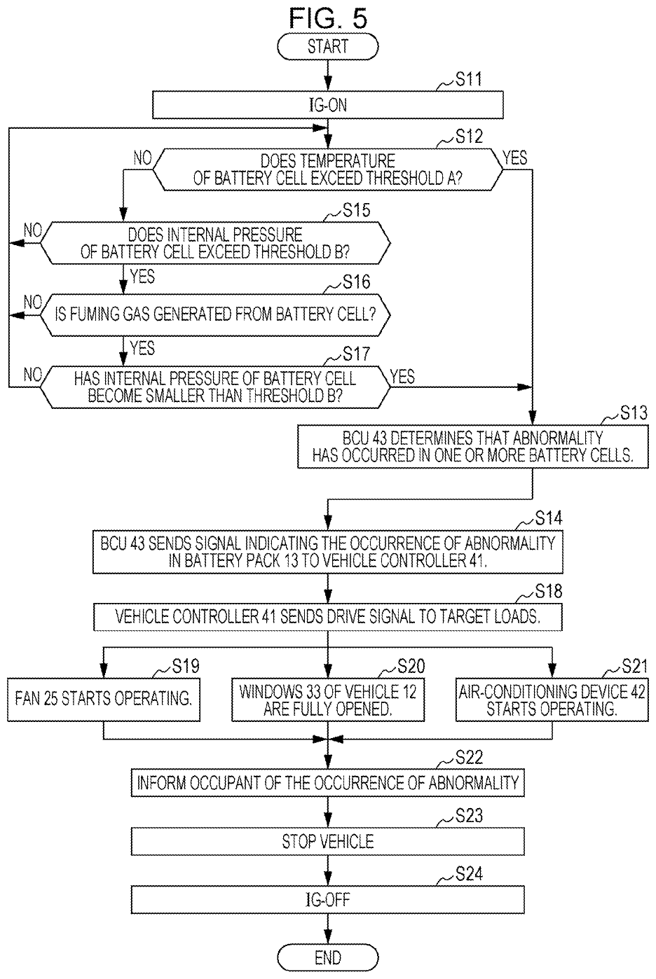

A description will now be given below in detail, with reference to FIGS. 4 and 5, of a control method for exhausting a fuming gas to the outside of the compartment of the vehicle 12 by using the second fumes exhaust path 32. Basically, the same member as that of the fumes exhaust structure 11 for the battery pack 10 discussed with reference to FIGS. 1 through 3 will be designated by like reference numeral and an explanation thereof will not be repeated.

FIG. 4 is a block diagram illustrating the fumes exhaust structure 11 of the embodiment for explaining a control method for exhausting a fuming gas via the second fumes exhaust path 32. FIG. 5 is a flowchart illustrating a control method for exhausting a fuming gas inside the fumes exhaust structure 11 of the embodiment to the outside of the compartment of the vehicle 12.

The vehicle controller 41 illustrated in FIG. 4 includes components such as a central processing unit (CPU), a read only memory (ROM), and a random access memory (RAM). The vehicle controller 41 is an electronic control unit (ECU) including one or multiple processors for executing various operations for controlling various devices, such as the air-conditioning device 42 for the vehicle 12, the fan 25, an opening/closing unit 47 for the windows 33 of the vehicle 12, and an engine (not illustrated).

The vehicle controller 41 also includes a storage (not illustrated). The storage is constituted by a non-volatile memory, such as an electrically erasable programmable read-only memory (EEPROM). Various items of data used for controlling the vehicle 12 and one or more programs that can be executed by one or multiple processors of the ECU are stored in the storage.

A battery control unit (BCU) 43 is a component forming the battery pack 10 and is disposed in the battery case 13. The BCU 43 is an electronic control device which is electrically coupled to the battery modules 21 and monitors and controls the battery cells of the battery modules 21. The BCU 43 is also electrically coupled to a pressure sensor 44, a temperature sensor 45, and a gas sensor 46. The pressure sensor 44 measures the internal pressure of a battery cell. The temperature sensor 45 measures the temperature of a battery cell. The gas sensor 46 detects a fuming gas generated from a battery cell. In one embodiment, the BCU 43 may serve as an “abnormality detector”. The abnormality detector detects an abnormality of a battery cell of the battery modules 21 by suitably using detection results, such as input signals, output from the pressure sensor 44, the temperature sensor 45, and the gas sensor 46. A junction box (not illustrated) is disposed in the battery case 13 and the BCU 43 is electrically coupled to the junction box.

The control method will now be described below with reference to the flowchart of FIG. 5. In step S11, an occupant, such as a driver, gets in the vehicle 12 and turns ON an ignition switch (not illustrated), and then, the vehicle 12 starts operating. Then, AC converted from DC in the inverter 15 is supplied to various loads of the vehicle 12, such as the driving motor, in accordance with the driving state of each load.

In step S12, the BCU 43 checks the temperature of each battery cell of the battery modules 21 by using an input signal from the temperature sensor 45 and determines whether the temperature of any of the battery cells exceeds a set temperature, which corresponds to a threshold A.

If the BCU 43 has determined that the temperature of one or more of the battery cells of the battery modules 21 exceeds the threshold A (YES in step S12), the process proceeds to step S13. In step S13, the BCU 43 determines that an abnormality has occurred in one or more of the battery cells. Then, in step S14, the BCU 43 sends an abnormality signal indicating a battery module 12 including one or more battery cells in which the occurrence of an abnormality has found to the vehicle controller 41.

If the BCU 43 has determined that there is no battery cell whose temperature exceeds the threshold A (NO in step S12), the process proceeds to step S15. In step S15, the BCU 43 checks the internal pressure of each battery cell of the battery modules 21 by using an input signal from the pressure sensor 44 and determines whether the internal pressure of any of the battery cells exceeds a set internal pressure, which corresponds to a threshold B.

If the BCU 43 has determined that the internal pressure of one or more of the battery cells of the battery modules 21 exceeds the threshold B (YES in step S15), the process proceeds to step S16. In step S16, the BCU 43 determines based on an input signal from the gas sensor 46 whether a fuming gas is generated from any of the battery cells.

If the BCU 43 has determined that a fuming gas is generated from any of the battery cells (YES in step S16), the process proceeds to step S17. In step S17, the BCU 43 determines based on an input signal from the pressure sensor 44 whether the internal pressure of each battery cell whose internal pressure is found to exceed the threshold B in step S15 has become smaller than the threshold B.

If the BCU 43 has determined that the internal pressure of each battery cell whose internal pressure is found to exceed the threshold B in step S15 has become smaller than the threshold B (YES in step S17), the process proceeds to step S13. Then, the BCU 43 determines in step S13 that an abnormality has occurred in one or more of the battery cells. Then, in step S14, the BCU 43 sends an abnormality signal indicating a battery module 12 including one or more battery cells in which the occurrence of an abnormality has found to the vehicle controller 41.

If the BCU 43 has determined in step S15 that there is no battery cell whose internal pressure exceeds the threshold B (NO in step S15), or if the BCU 43 has determined that a fuming gas is not generated from any battery cell (NO in step S16), or if the BCU 43 has determined that any one of the battery cells whose internal pressure is found to exceed the threshold B in step S15 has not become smaller than the threshold B (NO in step S17), the process returns to step S12.

In step S18, the vehicle controller 41 sends a drive signal to the fan 25, the opening/closing unit 47 for the windows 33 of the vehicle 12, and the air-conditioning device 42 so as to exhaust a fuming gas flowing into the battery case 13 to the outside of the compartment of the vehicle 12 via the second fumes exhaust path 32.

In step S19, the fan 25 starts operating to blow air and part of cooling air flowing through the inside of the battery case 13 toward the communicating port of the battery case 13. The air and cooling air contain a fuming gas having leaked from the fumes exhaust duct 22. As discussed above, the fuming gas is sent to the inside of the compartment of the vehicle 12 via the inverter casing 16. While the fan 25 keeps operating, the fuming gas inside the battery case 13 is actively sent to the inside of the compartment of the vehicle 12 via the inverter casing 16.

In step S20, the opening/closing unit 47 for the windows 33 are operated to automatically open the windows 33 of the vehicle 12. In this case, the windows 33 are fully opened. As stated above, as a result of the windows 33 being opened, the second fumes exhaust path 32 functions. Then, the fuming gas sent to the inside of the compartment of the vehicle 12 via the inverter casing 16 is exhausted to the outside of the compartment through the windows 33.

In the embodiment, all the windows in the vehicle 12, such as the windows on the side of the rear seat, that of the driver's seat, and that of the passenger seat, are used as the windows 33 of the vehicle 12 through which a fuming gas is exhausted to the outside of the compartment. At least the windows on the side of the rear seat are included in the second fumes exhaust path 32 since the battery pack 10 is stored under the rear floor. When a fuming gas is exhausted via the second fumes exhaust path 32, the windows 33 may not necessarily be fully opened. The windows 33 may be opened wide enough to exhaust a fuming gas to the outside of the compartment of the vehicle 12.

In step S21, the air-conditioning device 42 of the vehicle 12 starts operating so that an airflow is generated inside the compartment of the vehicle 12. This encourages a fuming gas to be exhausted to the outside of the compartment of the vehicle 12 through the open windows 33. At this time, by switching the air-conditioning device 42 to an outside air intake mode, a fuming gas does not keep recirculating in the compartment of the vehicle 12. While outside air is being taken into the compartment of the vehicle 12, air inside the compartment is exhausted to the outside of the compartment through the open windows 33. It is thus less likely that a fuming gas becomes highly concentrated inside the compartment and adversely influences occupants in the vehicle 12.

In step S22, the vehicle controller 41 informs an occupant in the vehicle 12 of the occurrence of an abnormality in the battery module 21 by displaying certain information on a multifunction display or turning ON an alarm lamp or generating an alarm sound or voice.

In step S23, an occupant in the vehicle 12 recognizes the occurrence of an abnormality in the battery module 21 and stops the vehicle 12 at a safe place, such as the shoulder of a road or a nearby parking lot. Then, in step S24, after stopping the vehicle 12, the occupant turns OFF the ignition switch. The vehicle 12 then stops operating.

In the fumes exhaust structure 11 for the battery pack 10 according to the embodiment, as a result of opening the windows 33 of the vehicle 12, a fuming gas sent to the inside of the compartment of the vehicle 12 from the inverter casing 16 is exhausted to the outside of the compartment via the second fumes exhaust path 32. However, a fuming gas may be exhausted to the outside of the compartment in a different manner. For example, the second fumes exhaust path 32 may include a path of an exhaust pipe. One end of the exhaust pipe may communicate with the inverter casing 16 via the air outlet 16B, while the other end may be disposed outside the compartment of the vehicle 12. In this case, a fuming gas sent to the inverter casing 16 from the battery case 13 via the fan 25 flows out to the exhaust pipe and is then exhausted to the outside of the compartment of the vehicle 12. Various other modifications may be made to the embodiment without departing from the spirit and scope of the disclosure.

A fumes exhaust structure for a battery pack according to an embodiment of the disclosure has a first fumes exhaust path using a fumes exhaust duct which communicates with a battery cell and a second fumes exhaust path using a cooling air channel of an inverter. If a fuming gas is generated from the battery cell due to an abnormality in a battery module, it is exhausted to the outside of the compartment of the vehicle by using the first and second fumes exhaust paths. This structure makes it possible to prevent a fuming gas containing toxic substances from filling the compartment of the vehicle and thus to protect occupants from the fuming gas.

1. A fumes exhaust structure for a battery pack, the fumes exhaust structure being configured to exhaust a fuming gas from inside of a battery case to outside of a compartment of a vehicle, the fuming gas being to be generated in a battery cell of a battery module stored in the battery case due to an abnormality in the battery module, the fumes exhaust structure comprising:
a fumes exhaust duct disposed near the battery module so as to communicate with the battery cell;
an inverter configured to convert a current output from the battery module;
an inverter casing for the inverter, the inverter casing being disposed on a periphery of the battery case so as to communicate with the battery case; and
a fan disposed inside the battery case and configured to send air inside the battery case to the inverter casing,
the fumes exhaust structure having
a first fumes exhaust path to be used to exhaust the fuming gas to outside of the compartment of the vehicle via the fumes exhaust duct, and
a second fumes exhaust path to be used to exhaust the fuming gas from the battery case to outside of the compartment of the vehicle via the inverter casing.

2. The fumes exhaust structure according to claim 1, wherein the inverter casing has an air inlet and an air outlet, the air inlet being to be used to take the air inside the battery case into the inverter casing, the air outlet being to be used to exhaust the air taken into the inverter casing to inside of the compartment of the vehicle.

3. The fumes exhaust structure according to claim 2, further comprising:
an abnormality detector configured to perform a detection of an abnormality of the battery cell; and
a vehicle controller configured to control the fan and a window of the vehicle based on a result of the detection received from the abnormality detector, wherein
the vehicle controller is configured such that, in a case where an abnormality signal indicating an abnormality of the battery cell is output to the vehicle controller from the abnormality detector, the vehicle controller drives the fan so as to send the fuming gas inside the battery case to the inverter casing and also opens the window so as to exhaust the fuming gas to outside of the compartment of the vehicle from the inverter casing.

4. The fumes exhaust structure according to claim 3, wherein the abnormality detector determines based on the result of the detection whether an abnormality has occurred in the battery cell, the result of the detection including a detection result output from one or more of a temperature sensor, a pressure sensor, and a gas sensor, the temperature sensor being to be used to measure a temperature of the battery cell, the pressure sensor being to be used to measure an internal pressure of the battery cell, the gas sensor being to be used to detect the fuming gas.

5. The fumes exhaust structure according to claim 2, wherein:
the second fumes exhaust path includes a path of an exhaust pipe, the exhaust pipe being to be used to exhaust the fuming gas output to inside of the inverter casing via the fan to outside of the compartment of the vehicle; and
the exhaust pipe communicates with the inverter casing via the air outlet.
